(19) United States
(12) Patent Application Publication
(10) Pub. No.: US 2024/0095303 A1
(43) Pub. Date: Mar. 21, 2024

(54) COMPUTER-READABLE RECORDING MEDIUM STORING MATRIX OPERATION PROGRAM, MATRIX OPERATION METHOD, AND INFORMATION PROCESSING APPARATUS

(71) Applicant: Fujitsu Limited, Kawasaki-shi (JP)

(72) Inventors: Koji KURIHARA, Kawasaki (JP); Kentaro KAWAKAMI, Kawasaki (JP)

(73) Assignee: Fujitsu Limited, Kawasaki-shi (JP)

(21) Appl. No.: 18/337,671

(22) Filed: Jun. 20, 2023

(30) Foreign Application Priority Data
Sep. 15, 2022 (JP) 2022-147180

(51) Int. Cl. G06F 17/16; G06Q 30/0201

(52) U.S. Cl. CPC G06F 17/16; G06Q 30/0201

(57) ABSTRACT

A computer-readable recording medium stores a matrix operation program for a computer. In a matrix operation in which an arithmetic circuit executes processing that combines at least two columns included in a matrix, obtains a product of each of rows of the combined columns, and calculates a sum of the product of each of the rows for all combinations of columns in the matrix, the program causes the computer to divide the matrix into blocks of a column group based on a data size of the column and storage capacity of a second storage to be accessed by the arithmetic circuit prior to accessing a first storage that stores information related to the matrix such that the column group to be combined is contained in the second storage, and to execute the calculation processing for each block of the divided column group.

### CROSS-REFERENCE TO RELATED APPLICATION

This application is based upon and claims the benefit of priority of the prior Japanese Patent Application No. 2022-147180, filed on Sep. 15, 2022, the entire contents of which are incorporated herein by reference.

### FIELD

The embodiment discussed herein is related to a matrix operation program, a matrix operation method, and an information processing apparatus.

### BACKGROUND

In data analysis using a purchase history of a customer or the like, pattern mining processing is performed in which a product of individual elements of any two columns is obtained with respect to a matrix having a binary of 0 or 1 as an element value and a sum thereof is obtained. For example, when a customer (i) has purchased/has not purchased a product (j), the (i, j) component is expressed by a matrix with a binary of 1/0. By performing the pattern mining processing on this matrix, it becomes possible to investigate which product and which product are likely to be purchased simultaneously (number of customers who purchase simultaneously is larger as the sum is larger).

FIG. 15 is an explanatory diagram for explaining an outline of the pattern mining. As illustrated in FIG. 15, a matrix X expresses presence or absence of product purchase by a binary of 1/0 in each element having each customer identified by customer ID as a row and each product as a column. The information processing apparatus that executes the pattern mining selects any two columns from the matrix X (S101). In the illustrated example, a column of a product 1 and a column of a product 2 are selected.

Next, the information processing apparatus calculates a logical product (and) for each row of the selected two columns (S102), and calculates a sum (Sum_{(1,2)}) of logical product results of the individual rows (S103). The information processing apparatus performs the process of S101 to S103 for all combinations of columns.

Japanese Laid-open Patent Publication No. 2012-88880, Japanese Laid-open Patent Publication No. 2018-197906, U.S. Patent Application Publication No. 2019/0188239, and U.S. Patent Application Publication No. 2013/0132707 are disclosed as related art.

### SUMMARY

According to an aspect of the embodiments, a non-transitory computer-readable recording medium storing a matrix operation program for causing a computer to execute a process comprising: in a matrix operation in which an arithmetic circuit executes processing that combines at least two columns included in a matrix, obtains a product of each of rows of the combined columns, and calculates a sum of the product of each of the rows for all combinations of columns in the matrix, dividing the matrix into blocks of a column group based on a data size of the column and storage capacity of a second storage to be accessed by the arithmetic circuit prior to accessing a first storage that stores information related to the matrix such that the column group to be combined is contained in the second storage, and executing the calculation processing for each block of the divided column group.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a schematic diagram illustrating an exemplary overall configuration of an information processing apparatus according to an embodiment;

FIG. 2 is an explanatory diagram for explaining an outline of multithreading by a plurality of central processing unit (CPU) cores;

FIG. 3 is an explanatory diagram for explaining exemplary parallelization of matrix operations;

FIG. 4 is an explanatory diagram for explaining processing sharing by parallelization of matrix operations;

FIG. 5 is a flowchart illustrating an exemplary operation of the matrix operation;

FIG. 6 is an explanatory diagram for explaining an outline of data arrangement;

FIG. 7 is an explanatory diagram for explaining an outline of the data arrangement;

FIG. 8 is an explanatory diagram for explaining parallelization of matrix operations of the information processing apparatus according to the embodiment;

FIG. 9 is an explanatory diagram for explaining an outline of data arrangement of the information processing apparatus according to the embodiment;

FIG. 10 is an explanatory diagram for explaining an outline of the data arrangement of the information processing apparatus according to the embodiment;

FIG. 11 is a flowchart illustrating an exemplary operation of the matrix operation of the information processing apparatus according to the embodiment;

FIG. 12 is an explanatory diagram for explaining the matrix operation in a case where the number of combinations increases;

FIG. 13 is a flowchart illustrating an exemplary operation of the matrix operation in the case where the number of combinations increases;

FIG. 14 is an explanatory diagram for explaining an outline of data arrangement in the case where the number of combinations increases; and

FIG. 15 is an explanatory diagram for explaining an outline of pattern mining.

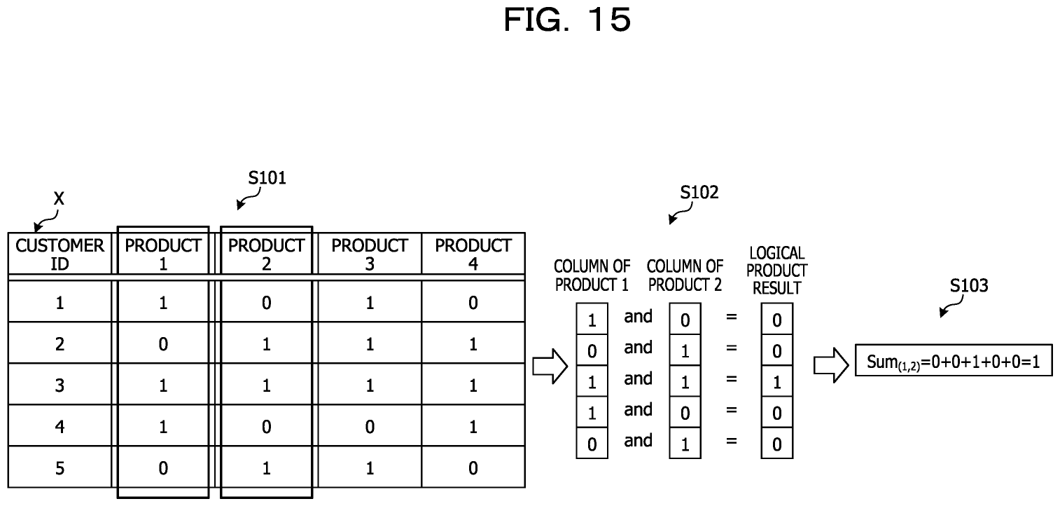

### DESCRIPTION OF EMBODIMENTS

In the pattern mining processing, a calculation amount explosively increases as the number of products to be combined increases. For example, in a case of performing the pattern mining processing on any two products out of the number N of products, combinations of _{N}C₂=N*(N−1)/2! need to be investigated. In a case of performing the pattern mining processing on combinations of any n products, _{N}Cₙ is obtained, and a calculation amount thereof is O(Nⁿ). Thus, speeding up of the process is a major problem when the pattern mining processing is performed on a large-scale N, n.

In one aspect, an object is to provide a matrix operation program, a matrix operation method, and an information processing apparatus capable of supporting speeding up of pattern mining processing.

Hereinafter, a matrix operation program, a matrix operation method, and an information processing apparatus according to an embodiment will be described with reference to the drawings. Configurations having the same functions in the embodiment are denoted by the same reference signs, and redundant description will be omitted. Note that the matrix operation program, the matrix operation method, and the information processing apparatus to be described in the embodiment below are merely examples, and do not limit the embodiment. Furthermore, each embodiment below may be appropriately combined unless otherwise contradicted.

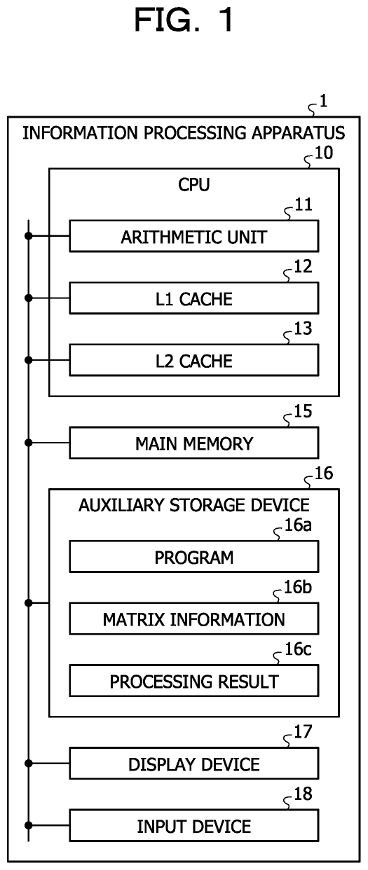

FIG. 1 is a schematic diagram illustrating an exemplary overall configuration of the information processing apparatus according to the embodiment. As illustrated in FIG. 1, an information processing apparatus 1 includes a central processing unit (CPU) 10, a main memory 15, an auxiliary storage device 16, a display device 17, and an input device 18. For example, a personal computer (PC) or the like may be applied as the information processing apparatus 1.

The CPU 10 includes an arithmetic unit (or an arithmetic circuit) 11, an L1 cache 12, and an L2 cache 13. The arithmetic unit 11 is coupled to each of the L1 cache 12, the L2 cache 13, the main memory 15, the auxiliary storage device 16, the display device 17, and the input device 18 by a bus.

The arithmetic unit 11 is, for example, a CPU core. The arithmetic unit 11 reads a program 16a or the like stored in the auxiliary storage device 16, loads it into the main memory 15, and carries out an operation using data stored in the L1 cache 12, the L2 cache 13, and the main memory 15. For example, the arithmetic unit 11 executes a matrix operation related to pattern mining processing (details will be described later).

The L1 cache 12 is a cache memory that operates faster and has a capacity smaller than that of the L2 cache 13, and is a cache memory to be read first at a time of data access by the arithmetic unit 11. The L1 cache 12 is, for example, a static random access memory (SRAM).

The L2 cache 13 is a cache memory that operates faster and commonly has a capacity larger than that of the L1 cache 12, and is a cache memory to be read next when a cache miss occurs in the L1 cache 12 at the time of data access by the arithmetic unit 11. For example, the L2 cache 13 is an exemplary storage unit to be accessed prior to the main memory 15 at the time of data access by the arithmetic unit 11. The L2 cache 13 is also an SRAM, for example.

Although the case where the information processing apparatus 1 includes two cache memories including the L1 cache 12 and the L2 cache 13 is described in the present embodiment, the number of layers of the cache memory is not limited to this, and for example, the information processing apparatus 1 may not include the L2 cache 13, or may include three or more layers including an L3 cache or more.

The main memory 15 is a main storage device having a lower operation speed (readout speed) and a larger capacity than those of the L1 cache 12 and the L2 cache 13. The main memory 15 stores data (e.g., matrix information 16b, processing result 16c, etc.) to be used by the arithmetic unit 11 for operations. The main memory 15 receives access from the arithmetic unit 11 when there is no data to be accessed in both of the L1 cache 12 and the L2 cache 13. The main memory 15 is, for example, a dynamic random access memory (DRAM).

The auxiliary storage device 16 is, for example, a hard disk drive (HDD), a solid state drive (SSD), or the like. The auxiliary storage device 16 stores an operating system (OS), the program 16a for performing an operation, the matrix information 16b related to a matrix to be operated, and the processing result 16c obtained by a matrix operation or the like.

The program 16a is program data for performing the matrix operation related to the pattern mining processing, and is an example of the matrix operation program.

The matrix information 16b is information related to a matrix X to be subject to the pattern mining processing. For example, the matrix information 16b indicates, when a customer (i) has purchased/has not purchased a product (j), each element of the matrix X in which the (i, j) component is a binary of I/O.

The processing result 16c is data indicating a result of the pattern mining processing in which at least two columns (products) are combined for the matrix X. For example, in the processing result 16c of the pattern mining processing in which two products (x, y) included in the matrix X are combined, the sum (Sum_{(x,y)}) of logical product results of individual rows is indicated for each of all combinations of the two products. Note that, since (x, y) and (y, x) are the same combination, one of them may not be processed (may not be included in the processing result 16c).

The display device 17 is, for example, a monitor, a display, or the like. The display device 17 presents the processing result 16c by the arithmetic unit 11 to a user, for example. The input device 18 is, for example, a keyboard, a mouse, or the like. The user inputs data and commands to the information processing apparatus 1 using the input device 18 while referring to a screen displayed on the display device 17. The display device 17 and the input device 18 may be configured as one piece of hardware.

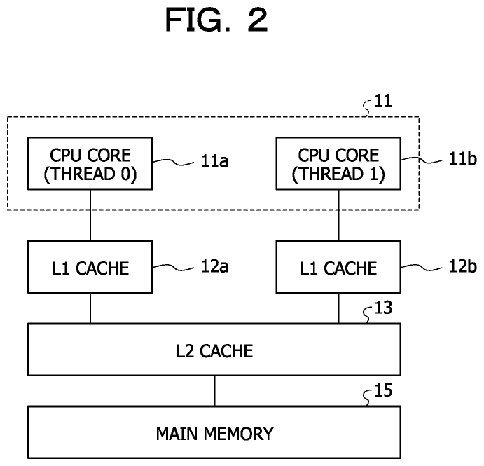

FIG. 2 is an explanatory diagram for explaining an outline of multithreading by a plurality of CPU cores. As illustrated in FIG. 2, each of a plurality of CPU cores 11a and 11b in the arithmetic unit 11 performs processing for one thread in the CPU 10, thereby implementing processing parallelization based on the multithread. For example, in the CPU 10, the CPU core 11a performs processing of a thread 0, and the CPU core 11b performs processing of a thread 1, whereby the two threads may be executed in parallel. Note that the number of cores (number of threads) in the arithmetic unit 11 is not limited to two, and may be one or three or more.

The CPU cores 11a and 11b are coupled to dedicated L1 caches 12a and 12b, respectively. Thus, pieces of data most recently accessed in the respective threads are independently stored in the L1 caches 12a and 12b for each thread. Furthermore, the L2 cache 13 is coupled to be accessible from both of the CPU cores 11a and 11b, and is shared in processing between threads.

Since there is no processing dependence relationship between column combinations in the matrix operation related to the pattern mining processing, processing may be performed in parallel (independently) for each combination. Accordingly, in the information processing apparatus 1, matrix operations are executed in parallel based on the multithread by the plurality of CPU cores 11a and 11b.

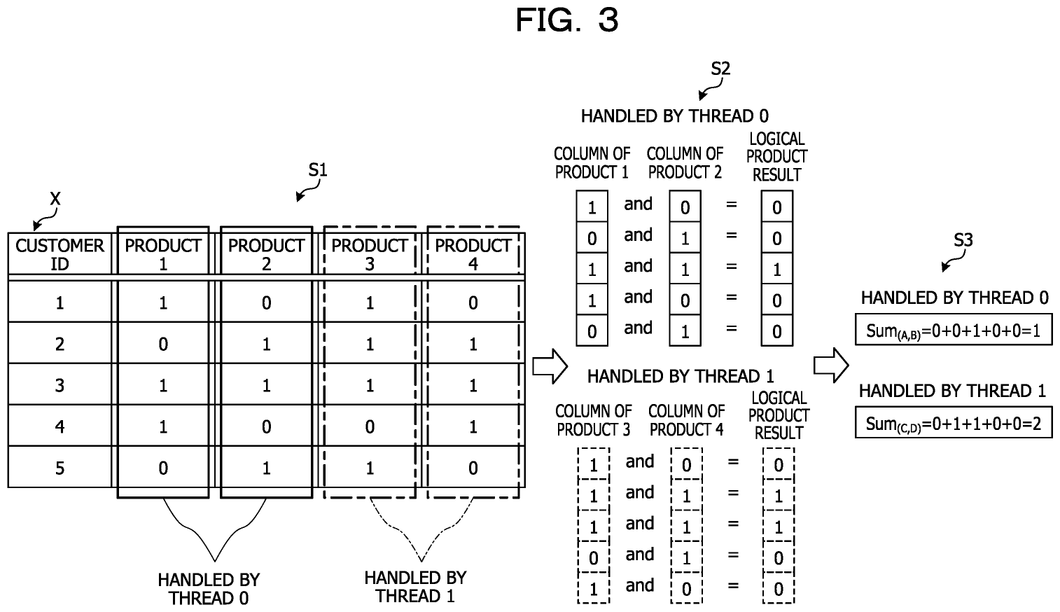

FIG. 3 is an explanatory diagram for explaining exemplary parallelization of matrix operations. For example, FIG. 3 exemplifies a case of performing matrix operations based on the pattern mining processing in the combination of two products (columns) in parallel by the two threads of threads 0 and 1.

As illustrated in FIG. 3, in the case of performing the matrix operations based on the pattern mining processing with the two threads, the CPU 10 selects any two columns to be handled by each of the two threads from the matrix X (S1). In the illustrated example, the columns are selected such that a column of a product 1 and a column of a product 2 (A, B) are to be handled by the thread 0 and a column of a product 3 and a column of a product 4 (C, D) are to be handled by the thread 1.

Next, each of the CPU cores 11a and 11b of the thread 0 and the thread 1 calculates a logical product (and) for each row of the two columns (S2), and calculates a sum (Sum_{(A,B)}, Sum_{(C,D)}) of logical product results of individual rows (S3). In this manner, the information processing apparatus 1 parallelizes and executes the matrix operations based on the multithread.

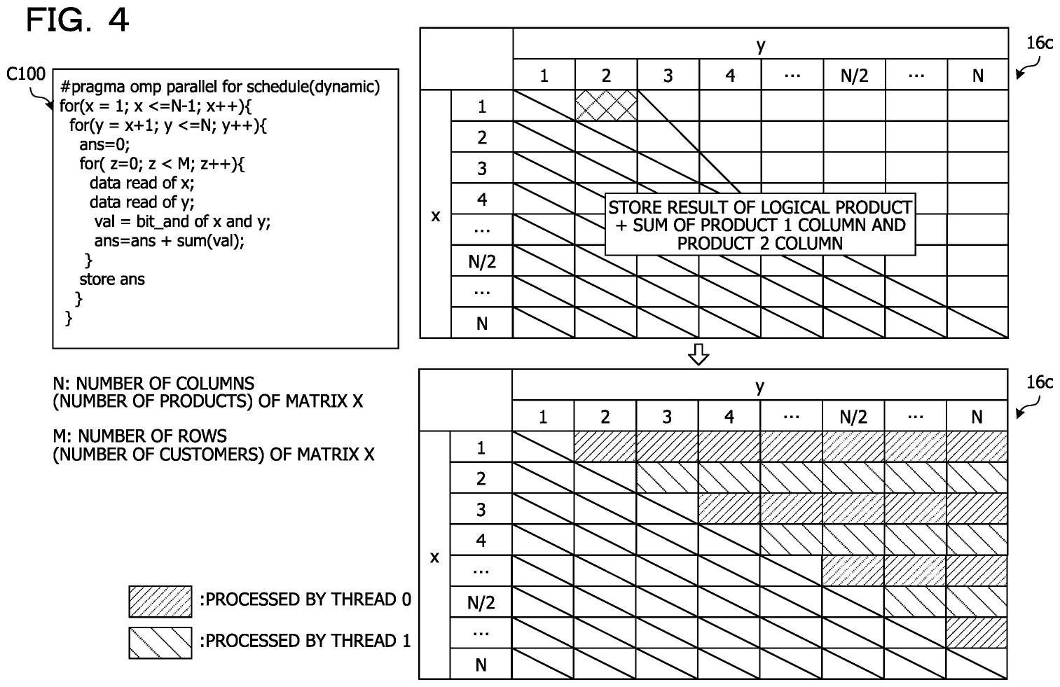

FIG. 4 is an explanatory diagram for explaining processing sharing by parallelization of matrix operations. Program code C100 in FIG. 4 is an example of common program code (pseudo code) that implements the pattern mining processing. The first line (description below #) of the program code C100 declares parallel processing based on multithreading, and processing in a loop in the following code and the like are to be performed in parallel. Furthermore, in the program code C100, N corresponds to the number of columns (number of products) of the matrix X, and M corresponds to the number of rows (number of customers) of the matrix X.

In the processing in the program code C100, the above-described operation is performed on two columns combined by performing increment sequentially from one specific column (x) in the matrix X and sequentially incrementing a column (y) other than x, thereby storing the processing results 16c for all combinations. For example, for a combination of the column of the product 1 and the column of the product 2 with (x, y) of (1, 2), the sum of logical products calculated for individual rows of the two columns is stored in the processing result 16c.

In a case where the above-described operation is shared and processed by two threads, for example, the lower part of FIG. 4 is obtained. For example, the thread 0 performs the operation of two columns combining the first column and a column other than the first column, and the thread 1 performs the operation of two columns combining the second column and a column other than the second column. Furthermore, the thread 0 performs the operation of two columns combining the third column and a column other than the third column, and the thread 1 performs the operation of two columns combining the fourth column and a column other than the fourth column. Likewise, in the following, an operation of two columns obtained by combining up to the N-th column and another column is shared and processed by the threads 0 and 1.

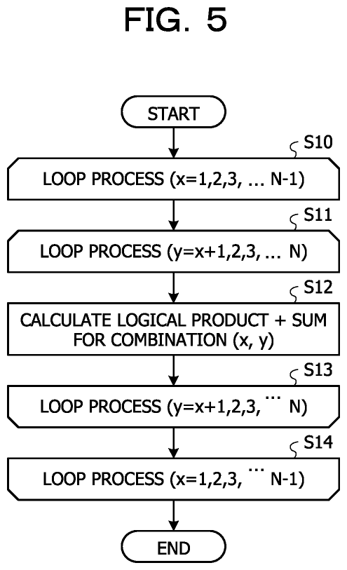

FIG. 5 is a flowchart illustrating an exemplary operation of the matrix operation, which illustrates, for example, exemplary pattern mining processing by the program code C100 exemplified in FIG. 4.

As illustrated in FIG. 5, when the process starts, the CPU 10 performs a loop process (S10 to S14) for sequentially designating one column (x) in the matrix X from the first to the (N−1)-th columns, and a loop process (S11 to S13) for sequentially designating another column (y) to be combined with the column of x from x+1 to N. In this loop process, each thread of the CPU cores 11a and 11b in the CPU 10 calculates a logical product of each row for the combined two columns (x, y), and calculates a sum of logical product results of individual rows (S12).

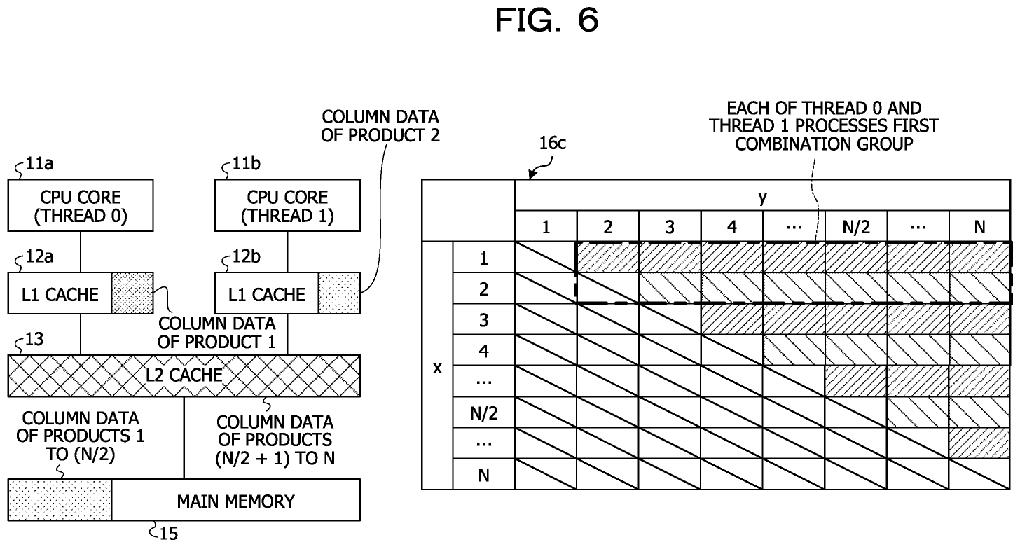

FIG. 6 is an explanatory diagram for explaining an outline of data arrangement. For example, FIG. 6 illustrates data arrangement after the thread 0 and the thread 1 of the CPU cores 11a and 11b have processed the first combination groups (thread 0: (1, 2 to N); and thread 1: (2, 3 to N)), respectively. Note that the storage capacity (cache size) of the L2 cache 13 is assumed to be a size equivalent to the column data of N/2 products.

As illustrated in FIG. 6, after each of the thread 0 and the thread 1 has processed the first combination group, the column data of the product 1 is stored in the L1 cache 12a, and the column data of the product 2 is stored in the L1 cache 12b. Furthermore, since the L2 cache 13 has the cache size of a size equivalent to the column data of the N/2 products and may not store all pieces of column data, the most recently processed column data is stored. For example, the L2 cache 13 stores column data of a product (N/2+1) to a product N.

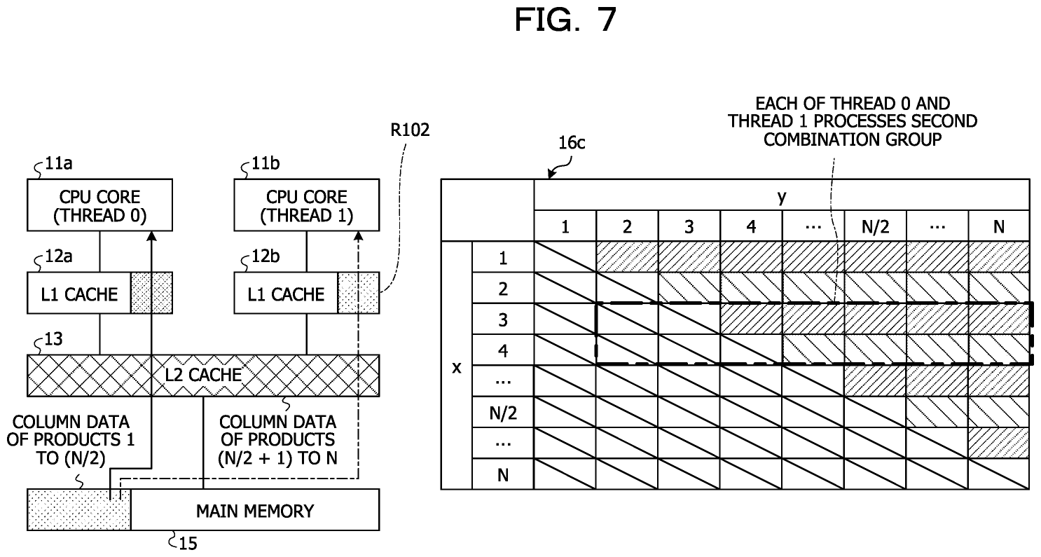

FIG. 7 is an explanatory diagram for explaining an outline of the data arrangement. For example, FIG. 7 illustrates data arrangement when the thread 0 and the thread 1 of the CPU cores 11a and 11b start to process the second combination groups (thread 0: (3, 4 to N); and thread 1: (4, 5 to N)), respectively.

As illustrated in FIG. 7, when each of the thread 0 and the thread 1 starts to process the second combination group, for example, column data related to the product 3 and the product 4 does not remain in the L2 cache 13. For example, the column data of the products 1 to (N/2) does not remain in the L2 cache 13. Thus, for the column data of the products 1 to (N/2), a cache miss occurs without a hit in the access to the L2 cache 13 prior to the main memory 15, and readout from the main memory 15 occurs every time each combination processing is performed.

For example, at the time of starting to process the second combination group, the CPU core 11a reads the column data of the product 3 and the product 4 from the main memory 15 (R101). Likewise, the CPU core 11b reads the column data of the product 4 and the product 5 from the main memory 15 (R102).

The number of clock cycles needed to such access to the main memory 15 is approximately 100 times larger than the number of clock cycles needed to access the L2 cache 13. Accordingly, the cache miss of the L2 cache 13 is a major factor that causes a decrease in the processing speed. For example, in a case where the number of products becomes larger and all pieces of data of the matrix X may not be stored in the L2 cache 13, the main memory 15 may be accessed at all times every time processing of a new combination group starts in the matrix operation described above.

In view of the above, in the matrix operation described above, the information processing apparatus 1 according to the embodiment divides the matrix X into column group blocks based on the column data size and the storage capacity (cache size) of the L2 cache 13 such that the column group to be combined is contained in the L2 cache 13. Then, the information processing apparatus 1 executes the matrix operation processing for each divided column group block. As a result, according to the information processing apparatus 1, it becomes possible to reduce a case where a cache miss of the L2 cache 13 occurs at the time of the matrix operation.

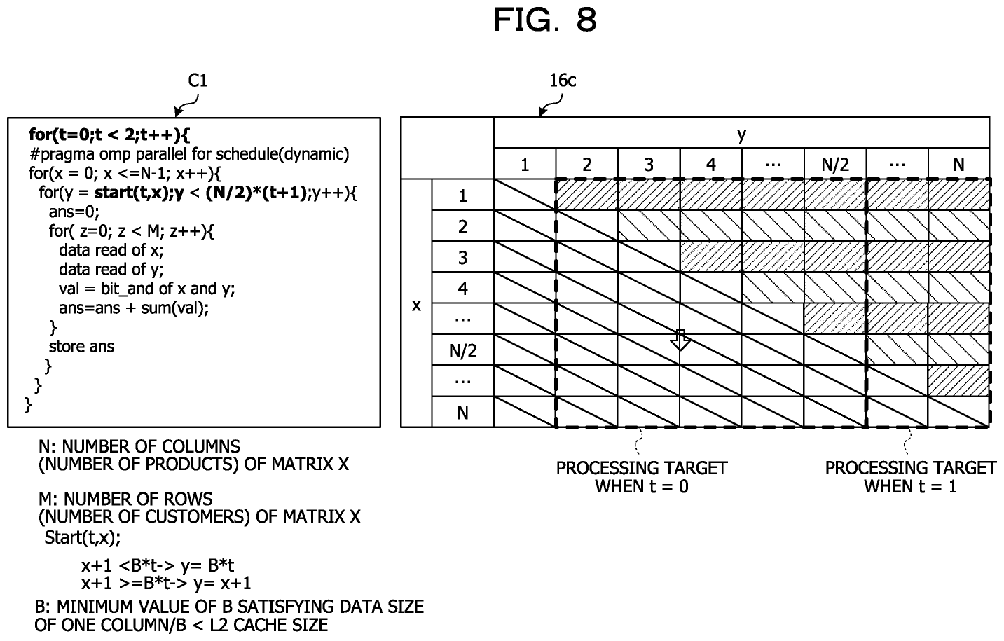

FIG. 8 is an explanatory diagram for explaining parallelization of matrix operations of the information processing apparatus 1 according to the embodiment. FIG. 8 exemplifies a case of performing matrix operations based on the pattern mining processing in the combination of two products (columns) in parallel by the two threads of threads 0 and 1.

Program code C1 in FIG. 8 is an example of program code (pseudo code) that executes the matrix operation processing for each divided column group block. In the program code C1, N corresponds to the number of columns (number of products) of the matrix X, and M corresponds to the number of rows (number of customers) of the matrix X. A function for obtaining a start row of y to be combined with the x-th row in each divided process (t=0, t=1) is represented by start(t, x). B represents the number of divided blocks obtained based on the column data size and the storage capacity (cache size) of the L2 cache 13. The number of blocks (B) to be divided is set to be the minimum value among values of B satisfying the data size of one column/B<(cache size of L2 cache 13).

For example, the storage capacity (cache size) of the L2 cache 13 is set to a size equivalent to the column data of N/2 products. Thus, it is assumed that the matrix X is divided into two groups of a column group related to the products 1 to N/2 and a column group related to the products N/2+1 to N.

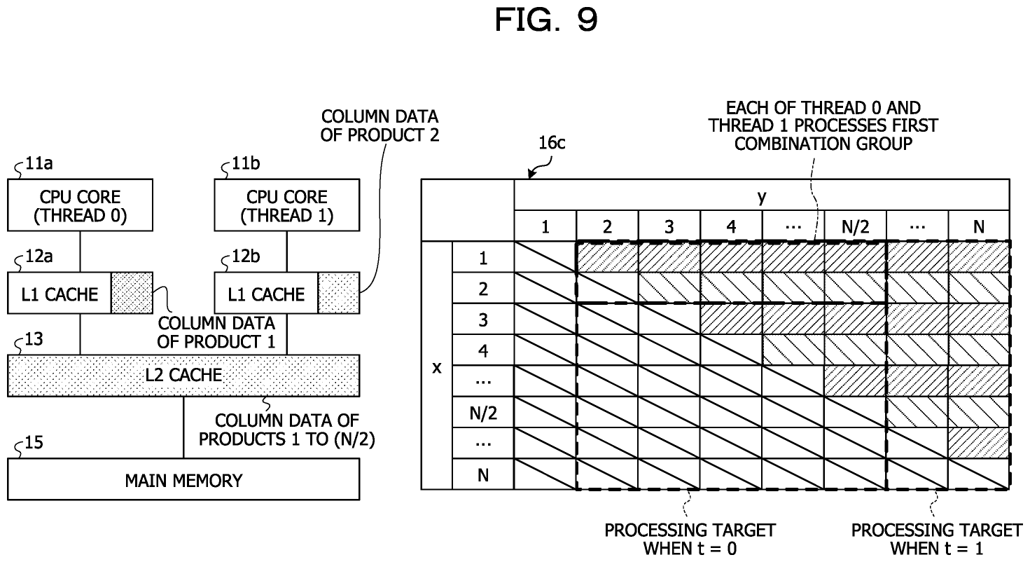

FIG. 9 is an explanatory diagram for explaining an outline of the data arrangement of the information processing apparatus 1 according to the embodiment. For example, FIG. 9 illustrates data arrangement after the thread 0 and the thread 1 of the CPU cores 11a and 11b have processed the first combination groups (thread 0: (1, 2 to N/2); and thread 1: (2, 3 to N/2)), respectively, in the divided column group of t=0.

As illustrated in FIG. 9, after each of the thread 0 and the thread 1 has processed the first combination group for the divided column group of t=0, the column data of the product 1 is stored in the L1 cache 12a, and the column data of the product 2 is stored in the L1 cache 12b. Furthermore, data of the divided column group of t=0 (products 1 to N/2) is stored in the L2 cache 13 as it is.

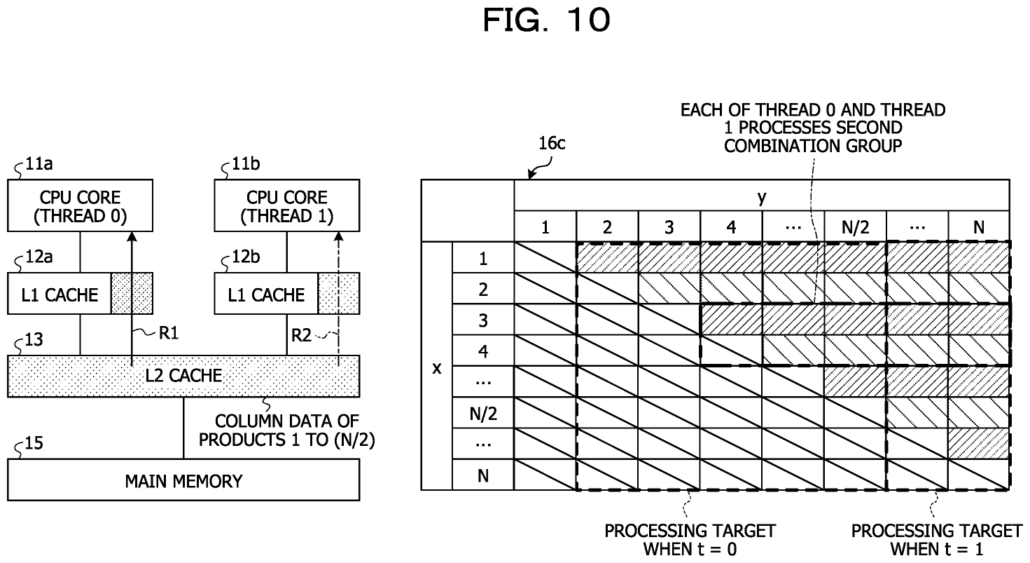

FIG. 10 is an explanatory diagram for explaining an outline of the data arrangement of the information processing apparatus 1 according to the embodiment. For example, FIG. 10 illustrates data arrangement when the thread 0 and the thread 1 of the CPU cores 11a and 11b start to process the second combination groups (thread 0: (3, 4 to N/2); and thread 1: (4, 5 to N/2)), respectively, for the divided column group of t=0.

As illustrated in FIG. 10, when each of the thread 0 and the thread 1 starts to process the second combination group for the divided column group of t=0, the data of the divided column group of t=0 (products 1 to N/2) remains in the L2 cache 13. Thus, the column data of the products 1 to (N/2) is hit by the access to the L2 cache 13 prior to the main memory 15. For example, at the time of starting to process the second combination group, the CPU core 11a reads the column data of the product 3 and the product 4 from the L2 cache 13 (R1). Likewise, the CPU core 11b reads the column data of the product 4 and the product 5 from the L2 cache 13 (R2).

In this manner, according to the information processing apparatus 1 according to the embodiment, it becomes possible to read the data needed for each combination process related to the divided column group of t=0 from the L2 cache 13 without a cache miss.

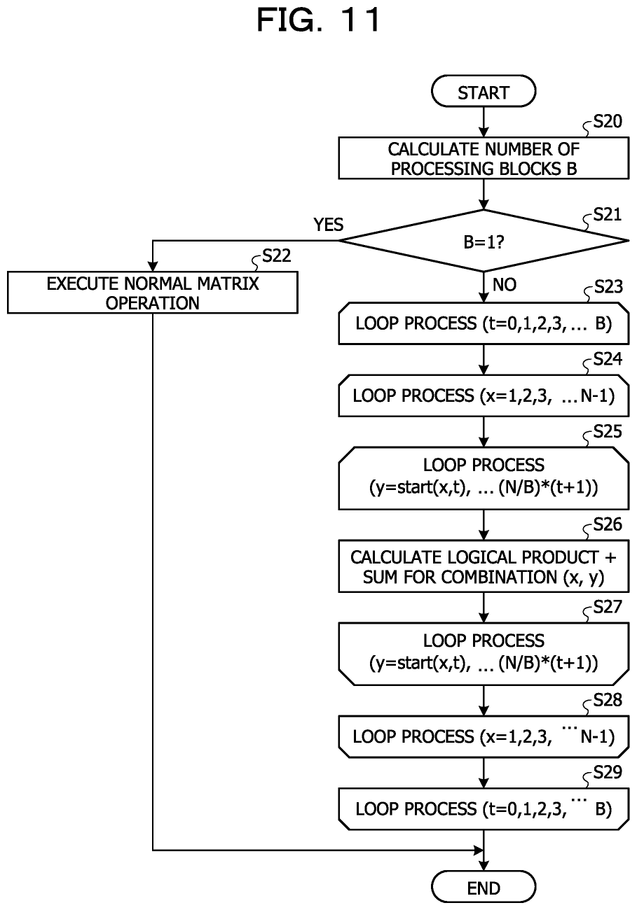

FIG. 11 is a flowchart illustrating an exemplary operation of the matrix operation of the information processing apparatus 1 according to the embodiment. As illustrated in FIG. 11, when the process starts, the CPU 10 calculates the number of processing blocks (B) to be divided as described above based on the column data size and the storage capacity (cache size) of the L2 cache 13 (S20).

Next, the CPU 10 determines whether or not the calculated number of blocks (B) is 1 (S21). If the number of blocks (B) is 1 (Yes in S21), all the columns of the matrix X are contained in the L2 cache 13 without dividing the matrix X, and thus the CPU 10 executes the normal matrix calculation (S22) exemplified in FIG. 5 and terminates the process.

If the number of blocks (B) is not 1 (No in S21), the CPU 10 divides the columns of the matrix X based on the number of blocks (e.g., equally makes division based on the number of blocks), and starts the loop process (t=0, 1, . . . , B) for each block (S23 to S29).

In the loop process for each block, the CPU 10 performs a loop process (S24 to S28) for sequentially designating one column (x) in the matrix X from the first to the (N−1)-th columns, and a loop process (S25 to S27) for sequentially designating another column (y) to be combined with the column of x from start(x, t) to (N/B)*(t+1). In this loop process, each thread of the CPU cores 11a and 11b in the CPU 10 calculates a logical product of each row for the combined two columns (x, y), and calculates a sum of logical product results of individual rows (S26).

Although the case of combining two products (columns) has been described in the pattern mining processing described above, two or more products (columns) may be combined in the pattern mining processing. Even in the case of combining two or more columns, it is possible to cope with the case by combining a new column with a result (column) of combining the two columns.

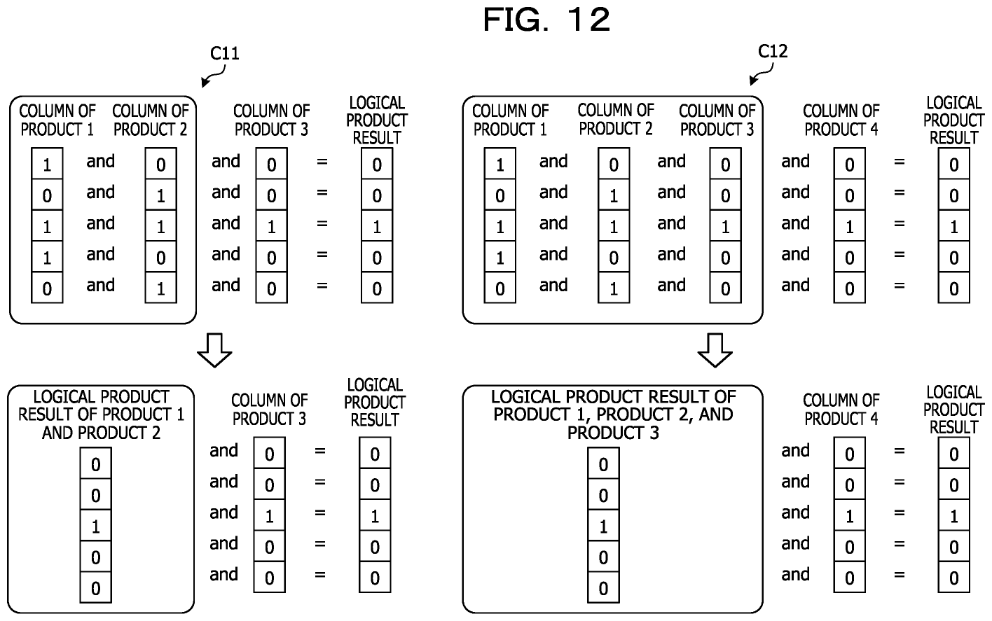

FIG. 12 is an explanatory diagram for explaining the matrix operation in a case where the number of combinations increases. As illustrated in FIG. 12, a case C11 is a case where a column of the product 3 is further combined with the combination of the column of the product 1 and the column of the product 2. In such a case of combining three columns, first, the information processing apparatus 1 combines the two columns (column of the product 1 and column of the product 2) to obtain a logical product. Next, the information processing apparatus 1 performs, by combining the third column (column of the product 3), the above-described matrix operation on the logical product result of each row in the combined two columns. As a result, the information processing apparatus 1 is enabled to obtain an operation result obtained by combining the three columns.

A case C12 is a case where a column of the product 4 is further combined with the combination of the three columns (combination of four columns). For such a combination of four columns, in a similar manner to the case C11, it is sufficient if the information processing apparatus 1 obtains a logical product result of the combination of the three columns (column of the product 1, column of the product 2, and column of the product 3), and then combines the fourth column (column of the product 4).

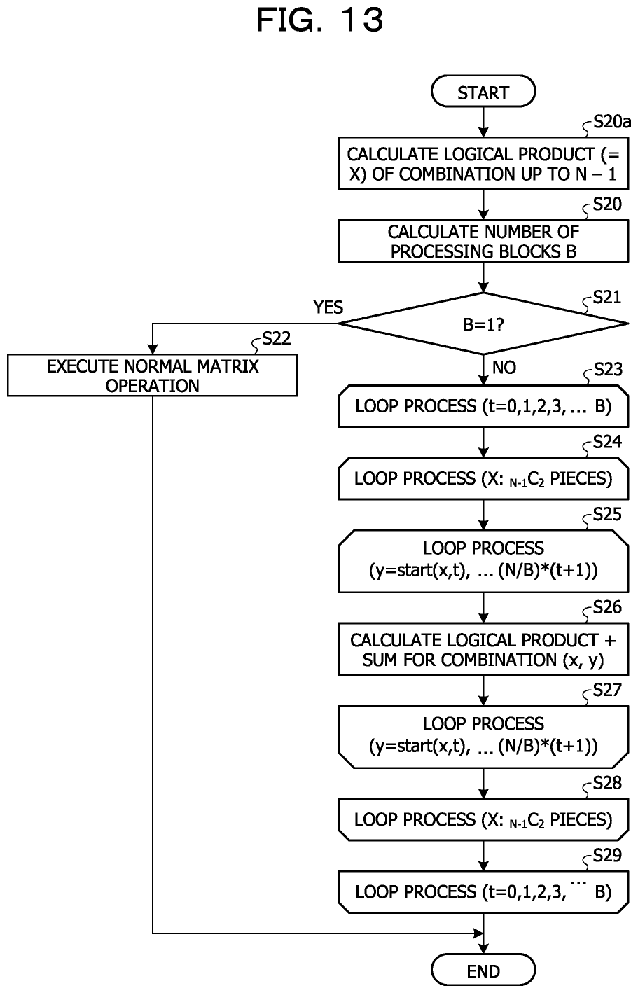

FIG. 13 is a flowchart illustrating an exemplary operation of the matrix operation in the case where the number of combinations increases. Note that the number of combinations (number of products) in this flowchart is assumed to be N. As illustrated in FIG. 13, the CPU 10 of the information processing apparatus 1 calculates a logical product (=X) of combinations up to N−1 as described above (S20a). Next, the CPU 10 executes the operation processing of combining another column (N) for the obtained logical product (=X) as in S20 to S29 described above.

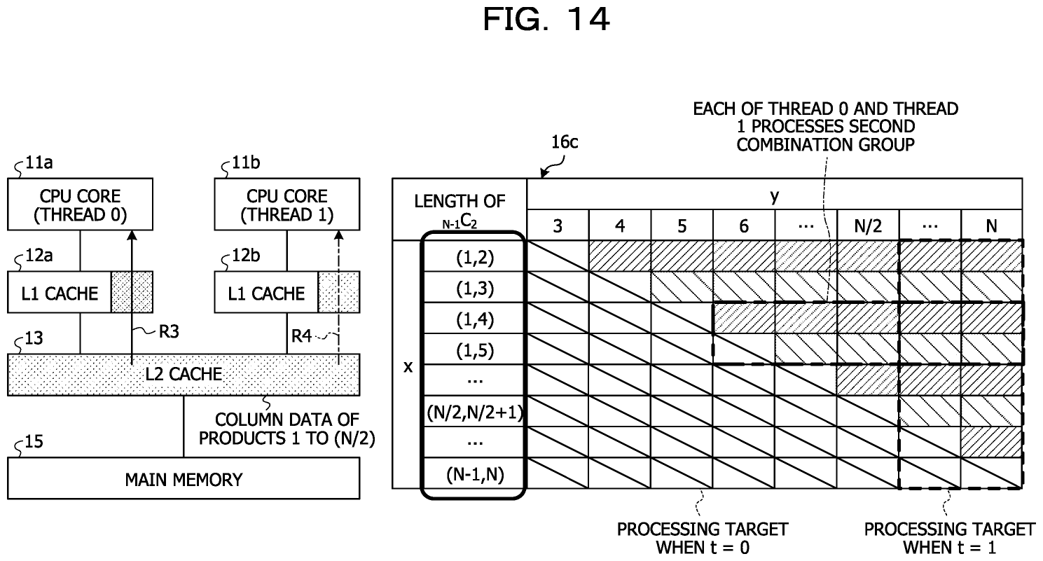

FIG. 14 is an explanatory diagram for explaining an outline of data arrangement in the case where the number of combinations increases. For example, FIG. 14 illustrates data arrangement when the thread 0 and the thread 1 of the CPU cores 11a and 11b start to process the second combination groups (thread 0: ((1, 4), 5 to N/2); and thread 1: ((1, 5), 6 to N/2)), respectively, for the divided column group of t=0.

As illustrated in FIG. 14, when each of the thread 0 and the thread 1 starts to process the second combination group for the divided column group of t=0, the data of the divided column group of t=0 (products 1 to N/2) remains in the L2 cache 13. Thus, the column data of the products 1 to (N/2) is hit by the access to the L2 cache 13 prior to the main memory 15. For example, at the time of starting to process the second combination group, the CPU core 11a reads the column data of the product 5 from the L2 cache 13 (R3). Likewise, the CPU core 11b reads the column data of the product 6 from the L2 cache 13 (R4).

In this manner, according to the information processing apparatus 1 according to the embodiment, even in the case where the number of combinations increases, it becomes possible to read the data needed for each combination process related to the divided column group of t=0 from the L2 cache 13 without a cache miss.

As described above, in the information processing apparatus 1, the matrix operation is performed in which the arithmetic unit 11 executes the process of combining at least two columns included in the matrix X, obtaining a product of each row of the combined columns, and calculating a sum of the products of the individual rows for all the combinations of the columns in the matrix X. In this matrix operation, the information processing apparatus 1 divides the matrix X into column group blocks based on a column data size and storage capacity of a second storage unit (L2 cache 13) to be accessed prior to a first storage unit (main memory 15) in which the arithmetic unit 11 stores information related to the matrix X such that the column group to be combined is contained in the second storage unit. The information processing apparatus 1 executes the calculation processing for each divided column group block.

As a result, in the information processing apparatus 1, when the column group to be combined is once stored in the second storage unit (L2 cache 13) at the time of calculation for each divided column group block, it remains in a state of being stored without being overwritten. Thus, according to the information processing apparatus 1, it becomes possible to reduce a case (cache miss) in which the first storage unit (main memory 15) is accessed in the matrix operation related to the pattern mining processing. For example, according to the information processing apparatus 1, it becomes possible to suppress a significant increase in the memory access time due to the cache miss, and to support speeding up of the pattern mining processing. Such speeding up of the pattern mining processing is effective for completing large-scale N, n pattern mining processing within a practical calculation time.

Furthermore, the information processing apparatus 1 makes division by the number of blocks of the minimum value satisfying (data size of one column)×(number of matrix columns of the matrix)/(number of blocks to be divided)<(storage capacity of L2 cache 13). By performing division in this manner, the information processing apparatus 1 is enabled to execute the matrix operation by efficiently using the storage area of the L2 cache 13.

Furthermore, when the number of blocks is 1, the information processing apparatus 1 executes the calculation process for all the combinations of the columns in the matrix X without performing division. As a result, the information processing apparatus 1 is enabled to perform the matrix operation without dividing the matrix X when the matrix X is contained in the L2 cache 13.

Furthermore, in each of the plurality of threads, the information processing apparatus 1 executes the process of sequentially combining one specific column in the matrix X with another column included in the column group to perform calculation. In this manner, the information processing apparatus 1 is enabled to perform the calculation process in each block at high speed by the parallelization using the plurality of threads.

Note that each of the illustrated components of the individual devices is not necessarily physically configured as illustrated in the drawings. For example, specific modes of distribution and integration of each device are not limited to those illustrated, and the whole or a part thereof may be configured by being functionally or physically distributed and integrated in any unit depending on various loads, use situations, or the like.

Furthermore, the program 16a related to the matrix operation and the like may not be stored in the auxiliary storage device 16. For example, the program 16a stored in a storage medium readable by the information processing apparatus 1 may be read and executed. The storage medium readable by the information processing apparatus 1 corresponds to, for example, a portable recording medium such as a compact disc read-only memory (CD-ROM), a digital versatile disc (DVD), or a universal serial bus (USB) memory, a semiconductor memory such as a flash memory, a hard disk drive, or the like. Furthermore, the program 16a may be stored in a device coupled to a public line, the Internet, a local area network (LAN), or the like, and the information processing apparatus 1 may read and execute the program 16a from them via a communication interface (not illustrated).

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a matrix operation program for causing a computer to execute a process comprising:
performing a matrix operation in which an arithmetic circuit
combines at least two columns included in a matrix,
obtains a product of each of rows of the combined columns, and
calculates a sum of the product of each of the rows for all combinations of columns in the matrix,
dividing the matrix into blocks of a column group based on a data size of the column and storage capacity of a second storage,
the second storage to be accessed by the arithmetic circuit prior to accessing a first storage,
the first storage stores information related to the matrix such that the column group to be combined is contained in the second storage; and
executing the calculation processing for each block of the divided column group.

2. The non-transitory computer-readable recording medium according to claim 1, wherein the matrix operation is included in data analysis of customer purchase history of at least one product.

3. The non-transitory computer-readable recording medium according to claim 1, wherein
the second storage includes a cache memory associated with a CPU core processing a thread, and
the first storage includes a main memory for multithreading by a plurality of CPU cores associated with a plurality of cache memories.

4. The non-transitory computer-readable recording medium according to claim 3, wherein the dividing divides the matrix into the blocks of the column group to avoid a cache miss that would decrease speed of the calculation processing.

5. The non-transitory computer-readable recording medium according to claim 1, wherein
the dividing performs division by a number of blocks of a minimum positive integer value that satisfies a following equation:
(data size of one column)×(number of columns)/(number of blocks to be divided)<(storage capacity of the second storage unit).

6. The non-transitory computer-readable recording medium according to claim 5, wherein
when the number of blocks is one, no division is performed and the calculation processing is executed for all the combinations of the columns in the matrix.

7. The non-transitory computer-readable recording medium according to claim 1, wherein
the executing executes, in each of a plurality of threads, the calculation processing by sequentially combining one specific column in the matrix with another column included in the column group.

8. A computer-implemented method of data analysis including a matrix operation, the method comprising:
performing a matrix operation in which an arithmetic circuit
combines at least two columns included in a matrix,
obtains a product of each of rows of the combined columns, and
calculates a sum of the product of each of the rows for all combinations of columns in the matrix,
dividing the matrix into blocks of a column group based on a data size of the column and storage capacity of a second storage,
the second storage to be accessed by the arithmetic circuit prior to accessing a first storage,
the first storage stores information related to the matrix such that the column group to be combined is contained in the second storage; and
executing the calculation processing for each block of the divided column group.

9. The non-transitory computer-readable recording medium according to claim 8, wherein the matrix operation is included in data analysis of customer purchase history of at least one product.

10. The non-transitory computer-readable recording medium according to claim 8, wherein
the second storage includes a cache memory associated with a CPU core processing a thread, and
the first storage includes a main memory for multithreading by a plurality of CPU cores associated with a plurality of cache memories.

11. The non-transitory computer-readable recording medium according to claim 10, wherein the dividing divides the matrix into the blocks of the column group to avoid a cache miss that would decrease speed of the calculation processing.

12. The matrix operation method according to claim 8, wherein
the dividing performs division by a number of blocks of a minimum positive integer value that satisfies a following equation:
(data size of one column)×(number of columns)/(number of blocks to be divided)<(storage capacity of the second storage unit).

13. The matrix operation method according to claim 12, wherein
when the number of blocks is one, no division is performed and the calculation processing is executed for all the combinations of the columns in the matrix.

14. The matrix operation method according to claim 13, wherein
the executing executes, in each of a plurality of threads, the calculation processing by sequentially combining one specific column in the matrix with another column included in the column group.

15. An information processing apparatus comprising:
a first storage storing information related to a matrix;
a processor coupled to the first storage; and
a second storage to be accessed by the processor prior to accessing the first storage,
wherein the processor is configured to:
performing a matrix operation in which an arithmetic circuit
combines at least two columns included in a matrix,
obtains a product of each of rows of the combined columns, and
calculates a sum of the product of each of the rows for all combinations of columns in the matrix,
dividing the matrix into blocks of a column group based on a data size of the column and storage capacity of a second storage,
the second storage to be accessed by the arithmetic circuit prior to accessing a first storage,
the first storage stores information related to the matrix such that the column group to be combined is contained in the second storage; and
executing the calculation processing for each block of the divided column group.

16. The non-transitory computer-readable recording medium according to claim 15, wherein
the second storage includes a cache memory associated with a CPU core processing a thread, and
the first storage includes a main memory for multithreading by a plurality of CPU cores associated with a plurality of cache memories.

17. The non-transitory computer-readable recording medium according to claim 16, wherein the dividing divides the matrix into the blocks of the column group to avoid a cache miss that would decrease speed of the calculation processing.

18. The information processing apparatus according to claim 15, wherein
the dividing performs division by a number of blocks of a minimum positive integer value that satisfies a following equation:
(data size of one column)×(number of columns)/(number of blocks to be divided)<(storage capacity of the second storage unit).

19. The information processing apparatus according to claim 18, wherein
when the number of blocks is one, no division is performed and the calculation processing is executed for all the combinations of the columns in the matrix.

20. The information processing apparatus according to claim 15, wherein
the executing executes, in each of a plurality of threads, the calculation processing by sequentially combining one specific column in the matrix with another column included in the column group.
